(19) United States
(12) Patent Application Publication
(10) Pub. No.: US 2009/0017413 A1
(43) Pub. Date: Jan. 15, 2009

(54) ORTHODONTIC BRACKET ASSEMBLY

(76) Inventor: Patrick Roman, Escondido, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/140,961

(22) Filed: Jun. 17, 2008

Related U.S. Application Data
(60) Provisional application No. 60/945,048, filed on Jun. 19, 2007.

(51) Int. Cl. A61C 7/26

(52) U.S. Cl. 433/24; 433/10

(57) ABSTRACT

An orthodontic assembly is adapted for attaching an archwire to a tooth. The assembly includes a body having a bracket and a base, wherein the bracket is adapted to be coupled to an archwire. The bracket and base are integrally formed as a single piece of material. An attachment portion is sized and shaped to be attached to a first region of the base, wherein the attachment portion includes an irregular contour adapted to couple to a bonding agent.

### REFERENCE TO PRIORITY DOCUMENT

This application claims priority of co-pending U.S. Provisional Patent Application Ser. No. 60/945,048, filed Jun. 19, 2007. Priority of the aforementioned filing date is hereby claimed and the disclosure of the Provisional Patent Applications is hereby incorporated by reference in its entirety.

### BACKGROUND

According to established orthodontic techniques, an orthodontic bracket assembly is attached to a patient's tooth. The bracket assembly provides a location for attaching an arch wire or other orthodontic device to facilitate movement of the tooth or collection of teeth in a predetermined manner. A conventional orthodontic bracket assembly includes a base portion that attaches to the tooth. The bracket assembly also includes a separate bracket portion that attaches to the arch wire. During a manufacturing process, the bracket is manually attached to the base to form the bracket assembly. The assembled bracket assembly is then bonded to a patient's tooth.

It is important that the bracket portion and the base portion of the bracket assembly be properly attached to one another according to a very precise alignment and spatial relationship. One reason for this is that the alignment between the bracket portion and the base portion will have a strong effect on the subsequent forces that are applied to the patient's teeth when the brackets are attached by the archwire. If the bracket and base are not properly aligned with one another, it can have an adverse impact on the subsequent orthodontic procedure on the patient.

Unfortunately, the manufacturing process of conventional bracket assemblies can lead to inconsistencies in the alignment between the bracket portion and base portion of the bracket assembly. As mentioned, each bracket is separately attached to each base. The manufacturing process is performed manually such as by a person spot welding the bracket portion onto the base portion. This process can be tedious, which often leads to the bracket portion being misaligned with the base portion. Moreover, the bracket-base alignment for one bracket assembly can be different from the bracket-base alignment for another bracket assembly. This is undesirable.

### SUMMARY

In view of the foregoing, there is a need for an improved bracket assembly that provides consistent alignment between the bracket and base. Disclosed is a an orthodontic assembly for attaching an archwire to a tooth, comprising: a body having a bracket and a base, wherein the bracket is adapted to be coupled to an archwire and wherein the base includes a first region, the bracket and base being integrally formed as a single piece of material; and an attachment portion sized and shaped to be attached to the first region of the base, wherein the attachment portion includes an irregular contour adapted to couple to a bonding agent.

Also disclosed is a method of manufacturing an orthodontic assembly for attaching an archwire to a tooth, the method comprising: using a molding process to form a body having a bracket and a base, wherein the bracket is adapted to be coupled to an archwire and wherein the base includes a first region, the bracket and base being integrally formed as a single piece of material; and attaching an attachment portion to the first region, the attachment portion sized and shaped to be positioned on the first region, wherein the attachment portion includes an irregular contour adapted to couple to a bonding agent.

Other features and advantages will be apparent from the following description of various embodiments, which illustrate, by way of example, the principles of the disclosed devices and methods.

### BRIEF DESCRIPTION OF THE DRAWINGS

FIG. 1 shows a top, perspective view of an exemplary embodiment of an orthodontic bracket assembly.

FIG. 2 shows a bottom, perspective view of the bracket assembly.

FIG. 3 shows perspective, exploded view of the bracket assembly.

FIG. 4 shows another perspective, exploded view of the bracket assembly.

FIG. 5 shows a bottom view of the bracket assembly.

FIG. 6 shows another perspective view of the bracket assembly.

FIG. 7 shows a side view of the bracket assembly.

### DETAILED DESCRIPTION

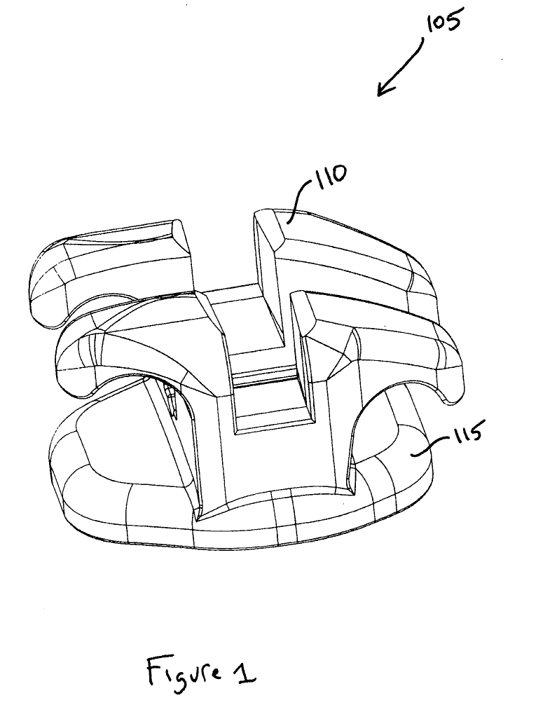

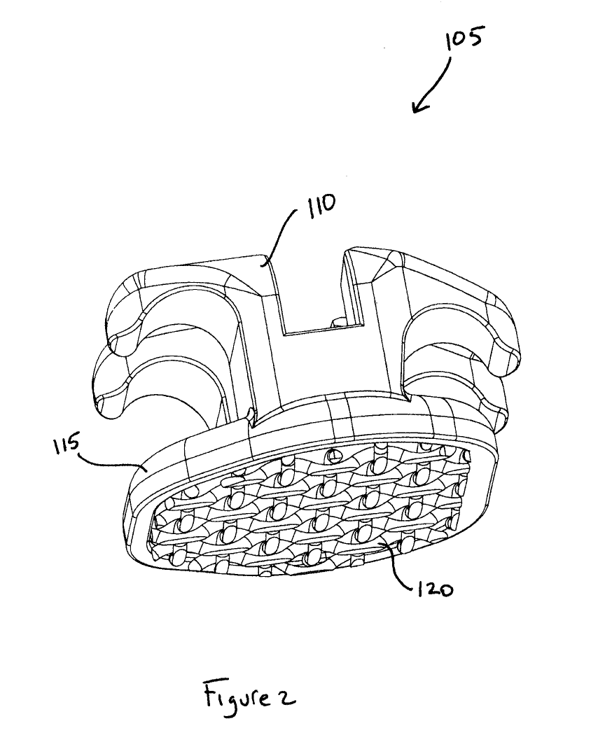

FIG. 1 shows a top, perspective view of an exemplary embodiment of an orthodontic bracket assembly 105. FIG. 2 shows a bottom, perspective view of the bracket assembly 105. The bracket assembly 105 includes a bracket 110 and a mounting base 115. The bracket 110 and the base 115 are integrally formed as a single piece of material. The bracket assembly 105 further includes an attachment member 120 that is attached to a first region of the base 105, such as by being mounted within or on a pocket or seat of the mounting base 115, as described in detail below. The attachment member 120 is adapted to facilitate attaching the bracket assembly 105 to a tooth. It should be appreciated that terms such as “top”, “bottom”, and “side” are for reference purposes only and should not be used to limit the scope of this disclosure. Moreover, it should be appreciated that the bracket assembly is not limited to the particular shape shown in the figures.

As discussed in detail below, the bracket 110 and the base 115 are formed of a single piece of material, such as via a molding process. This provides a precise and consistent alignment between the bracket 110 and base 115. Because a mold is used to manufacture the bracket assembly as a single piece, the alignment is maintained across a plurality of bracket assemblies.

The bracket assembly 105 is adapted for use with a series of similar brackets that are each mounted on a respective tooth. In this regard, the attachment member 120 and a bottom region of the base 115 are collectively sized and shaped to be attached onto the surface of a tooth. The base 115 and/or the attachment member 120 can have any contour or structure that facilitates attachment to the tooth. The attachment member 120 is adapted for combining with a bonding agent to provide an adhesive joining with the tooth. In the illustrated embodiment, the attachment member 120 comprises a mesh formed of an interconnected network of wire members arranged in a woven formation to collectively form a series of holes, cavities, or partial openings therebetween for the bonding agent. The attachment member 120 need not be a mesh but can be any structure or collection of structures, such as small projections, that form holes or irregularities for the bonding agent. Moreover, the attachment member 120 can be any structure of component that facilitates attachment of the bracket assembly to a tooth. In an embodiment, the attachment member is a smooth piece of material having any type of adhesive for attaching to a tooth.

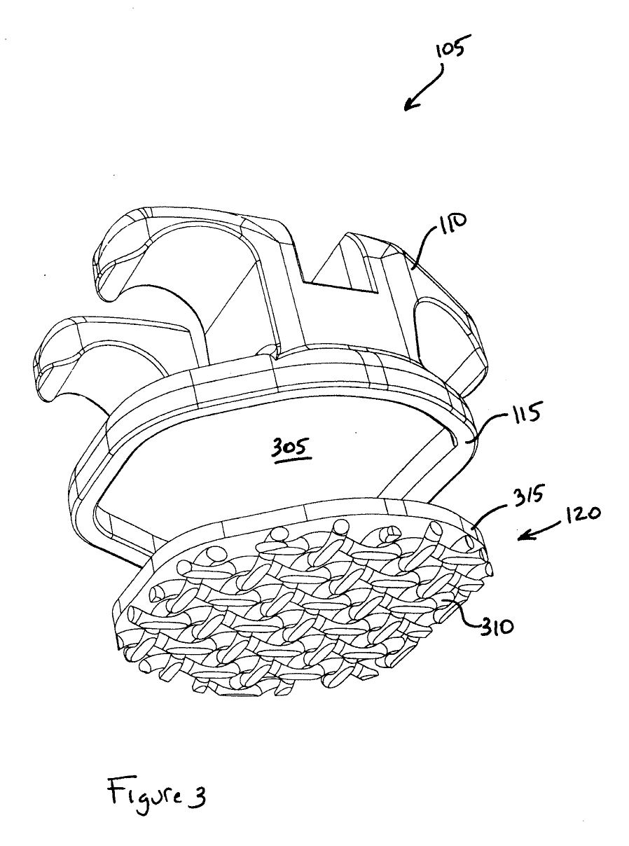

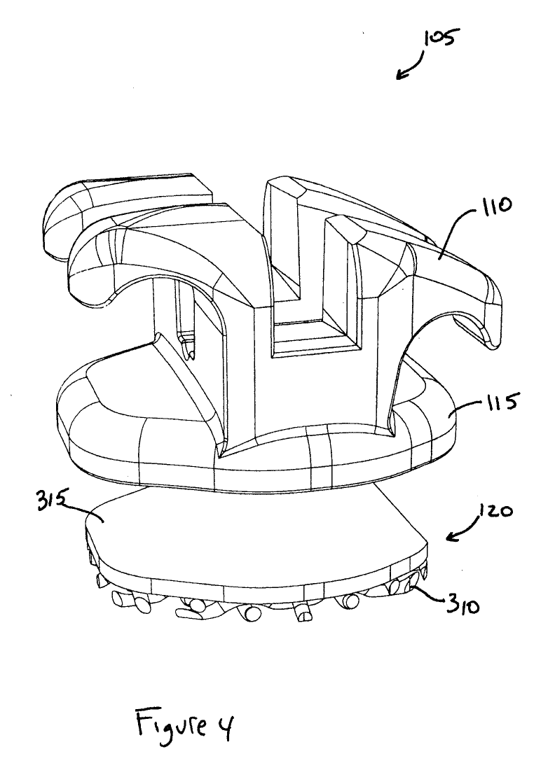

FIGS. 3 and 4 shows perspective, exploded views of the bracket assembly 105. As mentioned, the attachment member 120 is a separate structure with respect to the base 115 and integral bracket 110 that are formed as a single piece. The attachment member 120 is adapted to be coupled to the base 115. In this regard, the attachment member 120 can be mounted to the base in any manner. In an exemplary embodiment, the attachment member fits within a pocket or seat 305 in the base, although it should be appreciated that the attachment member need not attach to the base by being seated within a pocket or seat.

With reference to the example shown in FIGS. 3 and 4, the attachment member 120 is mounted on or within the seat 305 in the bottom region of the base 115. In this regard, the seat 305 is sized and shaped to receive the attachment member 120 therein. In the illustrated embodiment, the seat 305 is formed by downwardly-extending walls around the perimeter of the base member. The walls form a partially-enclosed seat in which the attachment member 120 fits. It should be appreciated that the seat 305 can be formed in any manner that facilitates the attachment member 120 being coupled to the base member 115. The attachment member 120 can fit snugly into the seat 305 or there can be any desired amount of play between the seat 305 and the attachment member 120. Moreover, the seat need not have a perimeter wall, but can simply be a flat surface to which the attachment member 120 is mounted. However, the perimeter wall advantageously provides a defined location where the attachment member 120 sits on the base 115. If present, the perimeter wall can extend entirely around the seat 305 or it can extend partially or intermittently around the seat 305.

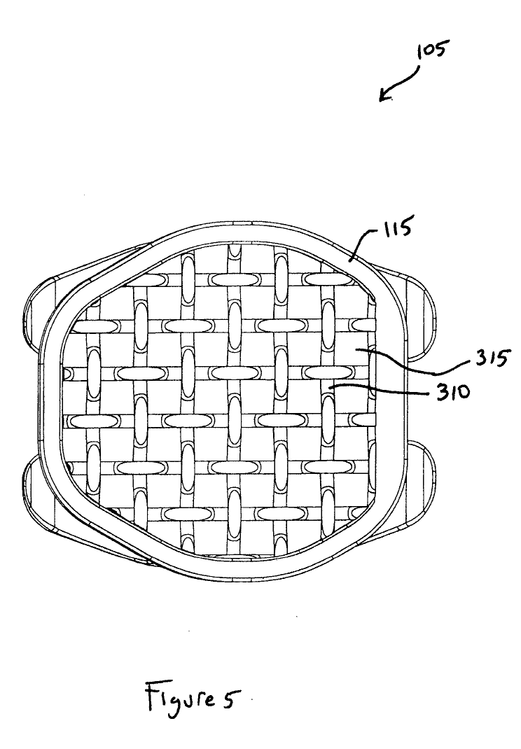

As shown in the bottom view of FIG. 5, in an embodiment the attachment member 120 comprises a mesh structure 310 of woven wires that form a plurality of holes or pockets therebetween for the bonding agent. The mesh structure 310 can be mounted on a member, such as a plate 315 (FIGS. 3 and 4), to facilitate positioning within the seat 305. Alternately, the mesh structure 310 can be positioned in the seat 305 without use of the plate 315. Also, the attachment member 120 can be formed in other manners, such as by a series of projections, pylons, or any other structure that form holes or cavities for the bonding agent.

The attachment member 120 can be secured within the seat 305 in any of a variety of manners. In an embodiment, a weld is used to secure the attachment member 120 within the seat 120. Alternately, an adhesive or any other means, whether mechanical or chemical, can be used to secure the attachment member 120 within the seat 305.

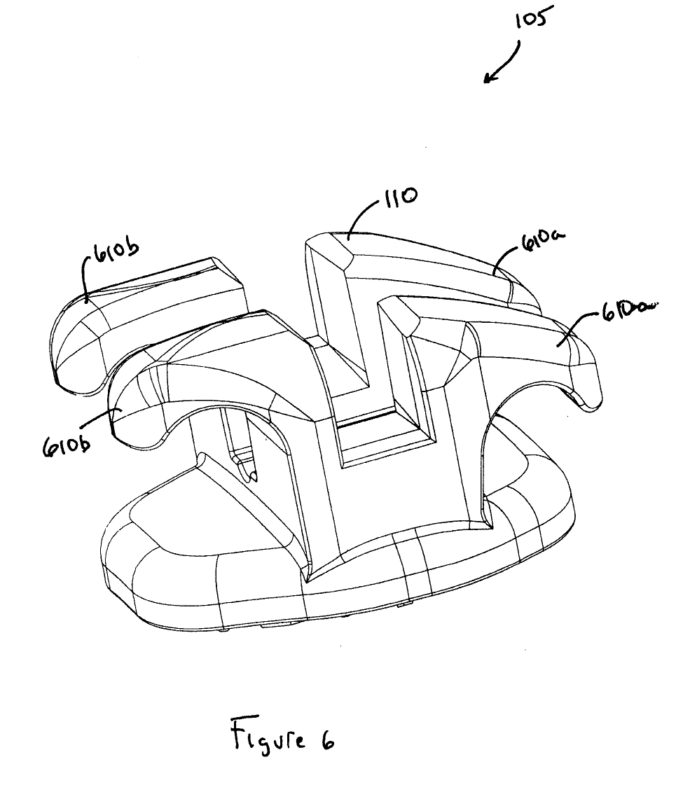

The bracket 110 can have any of a variety of configurations know to those skilled in the art. The bracket desirably is adapted to be coupled to an archwire. In this regard, the bracket 110 includes one or more wings that form interface regions for the archwire. With reference now to FIG. 6, the bracket 110 includes a pair of laterally-spaced wings 610a, 610b, and also a pair of laterally-spaced wings 615a, 615b. The wings 610a and 610b can be, for example, gingival tie wings. The wings 615a and 615b can be occlusal tie wings 18. The wings 610 and 615 curve lingually in the illustrated embodiment, although it should be appreciated that the wings can have various shapes and structures that differ from that shown in the figures.

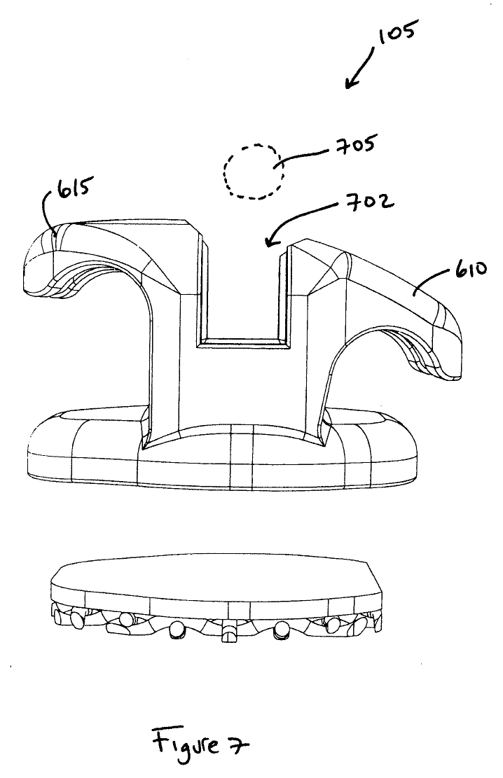

FIG. 7 shows an exploded side view of the bracket assembly 105. The pair of wings 610 is spaced from the pair of wings 615 so as to form an archwire slot 702 therebetween. The archwire slot 702 is sized and shaped to receive therein an archwire 705 for interconnecting the bracket assembly with one or more additional bracket assemblies positioned on other teeth. The bracket assemblies can also be interconnected with other ligating connectors such as wires and rubber bands.

As mentioned, the bracket 110 and base 115 are integrally manufactured as a unitary piece of material. In an embodiment, the bracket 110 and base 115 are manufactured via a molding process or a casting process although any process can be used to manufacture the bracket and base, including a stamping process. When molded, a single mold is used to manufacture the bracket 110 and the base 115 as a single, integrated piece. Because they are molded as a single piece, an exact spatial alignment is consistently maintained between the bracket 110 and the base 115. Thus, such a manufacturing process avoids discrepancies in relative alignment and orientation that can occur where the bracket and base are separately manufactured and then later attached to one another. Any of a variety of materials can be used to manufacture the bracket and base. For example, stainless steel, titanium, composite, ceramic, plastic, or combinations thereof are exemplary materials.

The attachment member 120 can be manufactured using any type of process. in an embodiment, the attachment member 120 is formed by cut-stamping the attachment member 120 out of a screen or mesh material. In another embodiment, the attachment member is formed using a molding process or a casting process. If manufactured using a mold, the attachment member 120 is molded separately from the bracket and base piece and then attached to the bracket/base at a later time. In another embodiment, the mesh structure 310 is manufactured by separately attaching a plurality of wires together to form the mesh. Alternately, the mesh structure can be molded. Any material can be used to manufacture the attachment member. In an embodiment, a material is used that promotes an adhesive attachment to the tooth. In an embodiment, stainless steel is used to manufacture the attachment member.

Once the bracket/base is formed and the attachment member is formed, the attachment member is secured to the base. For example, the attachment member 120 can be secured within the seat 305 of the base 115 using a weld, an adhesive, or any other attachment means. Advantageously, the bracket and base are always maintained in a precise and consistent spatial relationship because they are manufactured as a single piece. The attachment member does not necessarily have to be maintained in any precise spatial relationship with the remainder of the bracket assembly.

In use, the assembled bracket assembly 105 is bonded to a tooth using a suitable bonding material. The bracket assembly is positioned in an abutment relationship with the surface of the tooth and bonded thereto. As mentioned, a plurality of bracket assemblies 105 can be bonded to a plurality of teeth. An archwire is then coupled to the bracket assemblies to provide an interconnection therebetween for purposes of orthodontic correction of the teeth.

Although embodiments of various methods and devices are described herein in detail with reference to certain versions, it should be appreciated that other versions, embodiments, methods of use, and combinations thereof are also possible. Therefore, the spirit and scope of the instrument should not be limited to the description of the embodiments contained herein.

What is claimed:

1. An orthodontic assembly for attaching an archwire to a tooth, comprising:
a body having a bracket and a base, wherein the bracket is adapted to be coupled to an archwire and wherein the base includes a first region, the bracket and base being integrally formed as a single piece of material;
an attachment portion sized and shaped to be attached to the first region of the base, wherein the attachment portion includes an irregular contour adapted to couple to a bonding agent.

2. An orthodontic assembly as in claim 1, wherein the irregular contour of the attachment portion is a mesh.

3. An orthodontic assembly as in claim 1, wherein the irregular contour of the attachment portion is a plurality of projections.

4. An orthodontic assembly as in claim 1, wherein the irregular contour of the attachment portion includes a plurality of holes.

5. An orthodontic assembly as in claim 1, wherein the attachment portion includes a plate on which the irregular contour is positioned.

6. An orthodontic assembly as in claim 1, wherein the first region is a seat or pocket

7. An orthodontic assembly as in claim 6, wherein the seat or pocket is defined by a perimeter wall.

8. An orthodontic assembly as in claim 7, wherein the attachment portion fits within a space defined by the perimeter wall.

9. An orthodontic assembly as in claim 7, wherein the perimeter wall is a partial wall.

10. An orthodontic assembly as in claim 7, wherein the perimeter wall is an intermittent wall.

11. An orthodontic assembly as in claim 6, wherein the seat or pocket does not include a perimeter wall.

12. An orthodontic assembly as in claim 1, wherein the attachment portion is attached to the seat via a weld.

13. An orthodontic assembly as in claim 1, wherein the attachment portion is attached to the seat via an adhesive.

14. An orthodontic assembly as in claim 1, further comprising an archwire.

15. An orthodontic assembly as in claim 1, wherein the bracket includes at least one wing.

16. An orthodontic assembly as in claim 1, wherein the attachment portion is a plurality of projections forming spaces therebetween.

17. An orthodontic assembly as in claim 1, wherein the attachment portion is any structure that facilitates attachment of the orthodontic assembly to a tooth.

18. A method of manufacturing an orthodontic assembly for attaching an archwire to a tooth, the method comprising:
using a molding process to form a body having a bracket and a base, wherein the bracket is adapted to be coupled to an archwire and wherein the base includes a first region, the bracket and base being integrally formed as a single piece of material;
attaching an attachment portion to the first region, the attachment portion sized and shaped to be positioned on the first region, wherein the attachment portion includes an irregular contour adapted to couple to a bonding agent.

19. A method as in claim 13, wherein the attachment portion is attached to the first region via a weld.

20. A method as in claim 13, wherein the attachment portion is attached to the first region via an adhesive.
